(19) United States
(12) Patent Application Publication
(10) Pub. No.: US 2007/0210002 A1
(43) Pub. Date: Sep. 13, 2007

(54) CHEMICAL AND PROCESS FOR CLEANING MEMBRANES

(75) Inventors: Daniel Mullette, New South Wales (AU); Heinz-Joachim Muller, New South Wales (AU)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Water Technologies Corp

(21) Appl. No.: 11/573,151

(22) PCT Filed: Aug. 3, 2005
(86) PCT No.: PCT/AU05/01157

§ 371 Date: Feb. 2, 2007

(30) Foreign Application Priority Data
Aug. 4, 2004 (AU) 2004904430
Apr. 6, 2005 (AU) 2005901690

(51) Int. Cl. B01D 65/02

(52) U.S. Cl. 210/636; 210/615; 210/639; 210/759; 210/722; 210/804; 210/702

(57) ABSTRACT

A method for cleaning a microfiltration or ultrafiltration membrane comprising the step of contacting said membrane with a hydroxyl radical. The method is particularly suited for oxidation resistant membranes, such as Halar, with biological or organic fouling. The hydroxyl radicals for example are generated from an aqueous solution of transition metal ions, such as molybdenum, chromium, cobalt, copper, tungsten or more particularly iron, in conjunction with hydrogen peroxide under acidic conditions. The method is particularly suited to hollow fibre membranes where oxygen bubo es foamed in the course of the reaction create a flow that draws more liquid in through a wall of a vertical hollow fibre membrane and pushes water out of the top of the lumen, and where oxygen bubbles act to self agitate the solution which can break up a filter cake, where present, on the microfiltration or ultrafiltration membrane surface.

### TECHNICAL FIELD

The invention relates to compositions and processes for cleaning membranes, in particular to compositions and processes using hydroxyl radicals in the cleaning of polymeric microfiltration and ultrafiltration membranes.

### BACKGROUND ART

Polymeric microfiltration and ultrafiltration membranes have found widespread use in the filtration of water. The porous microfiltration and ultrafiltration membranes commonly in use are typically in the form of hollow fibres, which are potted into bundles. The bundles are then set into modules, which can further be arranged into banks of modules. In this way, membrane surface area is maximised for a given volume, and large water throughputs can be achieved by apparatus having a relatively small “footprint”.

In some modes of operation, contaminated feedwater is introduced into the modules in such a way as to be allowed to contact only the outside of the hollow fibres. The contaminated feed water may be pressurised if necessary to achieve passage of water across the membrane. When the water passes through the hollow fibre polymeric membranes, it accumulates inside the lumen of the fibre, from where it can thus be drawn off and used. The contaminants remain on the outside of the hollow fibres.

As these contaminant materials build up on the filter they reduce the overall permeability of the membrane. Thus, the volume of water that passes through the membrane at a given pressure is reduced, or alternatively, the amount of pressure needed to sustain a given membrane throughput is increased. In either case, the situation is undesirable, as the membrane will soon cease producing clean water altogether, or will need to operate at pressures which risk destroying the integrity of the membrane. For this reason the membranes need to be cleaned.

A large amount of the contaminants can be removed from the hollow fibre by periodic backwashing, i.e. forcing a gas or filtrate through the inside lumen of the hollow fibre membrane in a direction contra to the flow of the water such that the gas pushes contaminants from the membrane pores, into the surrounding water which can be drawn off and sent, for example, to a settling pond or tank. Membranes can likewise be cleaned by other forms of mechanical agitation if desired.

However, these mechanical and gas backwashing methods are not completely effective and over time their efficacy gradually decreases as the membranes become fouled by material which is not so readily removed by these means. Because of the nature of the material being filtered, which is often surface water, ground water purposes, membrane bioreactors and the like, much of the fouling agents are biological and/or organic in nature. Accordingly, additional cleaning steps are required.

Polymeric microfiltration and ultrafiltration membranes fouled with biological or organic matter have typically been cleaned by the use of oxidative cleaning agents such as sodium hypochlorite (chlorine), hydrogen peroxide and to a lesser extent ozone.

Chlorine is the most widely used cleaning agent however it is undesirable for widespread use as a water treatment chemical. Chlorine dosing in water treatment systems is a known cause of carcinogenic chlorinated organic by products. These are hazardous and can create environmental disposal problems. Chlorine gas itself, as well as having an unpleasant odour, is also a health hazard to those in the area.

The use of hydrogen peroxide can avoid issues related to hazardous and environmentally unsound chlorinated by-products, but is less efficient as a cleaning chemical when compared to chlorine.

Ozone is a more effective cleaning agent than chlorine or hydrogen peroxide, and also avoids many of the safety/environmental issues surrounding the use of chlorine. However membranes such as PVdF that resist oxidation by chlorine or peroxide are susceptible to degradation by ozone, as it is the more powerful oxidant.

Ozone and chlorine also suffer from the disadvantage that they can be involved in reaction pathways which result in the production of substances like trihalomethanes.

It is the object of the present invention to overcome or ameliorate at least one of the above mentioned disadvantages of the prior art.

### DESCRIPTION OF THE INVENTION

According to a first aspect, the invention provides a method for cleaning a microfiltration or ultrafiltration membrane comprising the step of contacting said membrane with a hydroxyl radical.

The microfiltration or ultrafiltration membrane can be made from any suitable oxidation resistant material, including but not limited to homopolymers, copolymers, terpolymers and the like, manufactured from any or all of the following fully or partially halogenated monomers including vinyl fluoride, vinyl chloride, vinylidene fluoride, vinylidene chloride, hexafluoropropylene, chlorotrifluoroethylene, and tetrafluroethylene. Particularly preferred blends or copolymers for microfiltration or ultrafiltration membranes are those made from polyvinylidene fluoride, i.e. PVdF, or copolymers of chlorotrifluoroethylene with ethylene, i.e. ECTFE (Halar), copolymers of chlorotrifluoroethylene with ethylene which incorporate one or more other monomer (such as acrylic esters) and polysulfones.

The hydroxyl radical may be generated by one or more methods selected from the group consisting of acidified hydrogen peroxide, organic peroxy acids, such as peracetic acid, combinations of hydrogen peroxide and organic peroxy acids, hydrogen peroxide under ultraviolet radiation, a combination of hydrogen peroxide and ozone with or without ultraviolet radiation, at a pH of between 2-9.

One preferred embodiment of the present invention involves the provision of hydroxyl radicals to an oxidation resistant membrane for cleaning purposes wherein the hydroxyl radicals are generated from an aqueous solution of transition metal ions, in conjunction with hydrogen peroxide under acidic conditions.

Preferably the transition metal ions are iron II and/or iron III. Preferably, the acidic conditions are a pH of between about pH 2-6

Any transition metal can be used, not just iron. Molybdenum, chromium, cobalt, copper or tungsten are also preferred. Any aqueous metal ion or complex that can easily be reduced/oxidised can be used as the catalyst system for the cleaning method of the present invention. Combinations of transition metal ions may also be used, and may be from a variety of sources, and can be supplemented with additional ions or species as necessary.

The transition metals can be added alone or as a complex with a chelating or other complexing agent. An example of a suitable chelating agent is citric acid.

Hydroxyl radicals are powerful oxidising agents, and thus represent a powerful method for removing fouling from membranes used in filtration, particularly in water filtration where large amounts of biological and/or organic fouling are found.

It has been found that a number of polymeric membranes, including PVdF, have a good resistance to hydroxyl radicals. This is surprising because polymeric membranes such as PVdF are not very stable with ozone even though hydroxyl radicals are considered more powerful oxidising agents than ozone for cleaning organics from fouled membranes. without wishing to be bound by theory, it is possible that the reason for this may be due to the short lifetime of hydroxyl radicals.

In one preferred embodiment, the solution of hydroxyl radicals is prepared from an aqueous solution of M⁽ⁿ⁺⁾ and/or M⁽ⁿ⁺¹⁾⁺ (for example, an iron II and/or iron III system) in conjunction with hydrogen peroxide at a low pH. Either M⁽ⁿ⁺⁾ and/or M⁽ⁿ⁺¹⁾⁺ will reach an appropriate equilibrium between the two species. For instance, it is possible to start with either ferrous or ferric species, to get an identical catalyst system. Other practicalities may dictate one over the other, for instance, when the metal is iron, preferably iron II species are used to start the reaction because they tend to be more soluble than any corresponding iron III species. Thus, the possibility of undissolved iron III salts is reduced when starting from a solution of iron II.

The invention will be described with respect to iron II and iron III, but it will be understood to apply to any system where hydroxyl radicals are generated.

The general scheme for preparing hydroxyl radicals by the redox catalyst/peroxide/H⁺ system of the present invention is as shown below. The reaction of either iron II or iron III with hydrogen peroxide is possible, generating the complementary iron species. Overall, it can be seen that the system is catalytic with respect to iron, and also that conservation of pH would be expected if there were no other influences on the reaction. However when used to clean membranes, the pH would be expected to decrease during the course of the reaction due to organic acids formed as organic foulants are decomposed.

| | |
|---|---|
| Fe²⁺ + H₂O₂ | Fe³⁺ + OH⁻ + HO· |
| Fe³⁺ + H₂O₂ | Fe²⁺ + ·OOH + H⁺ |

Overall:

| | |
|---|---|
| 2 H₂O₂ | H₂O + HO· + ·OOH |

The hydroxyl radical is a strong oxidant, having a relative oxidation power over two times greater than chlorine, and being second only to F⁻ in oxidative strength. It has been used to destroy organic pollutants, reduce toxicity and to control odours and colours in water.

The contacting of the membrane with hydroxyl radicals may occur alone or in combination with any other cleaning solution or method. A variety of methods are possible.

For example, the membrane may be soaked with the hydroxyl radical solution or have the hydroxyl radical solution filtered or recirculated through the membrane. The cleaning process may involve an aeration step, or a step of irradiating the solution with ultraviolet light to assist in cleaning.

Further, the cleaning solution once used may be recovered. The iron II/iron III system is catalytic and may be used to restart the cleaning process by the application of fresh amounts of hydrogen peroxide and an appropriate pH adjustment if required.

The redox catalyst/peroxide/H⁺ reagent may be utilised in a variety of ways. The individual redox catalyst/peroxide/H⁺ reagent components may be added together, or preferably separately, directly to the water which surrounds the fibre membranes. Alternatively, for example, when the redox catalyst/peroxide/H⁺ system uses iron II/iron III catalyst, the source of iron ions may be from the feed water to be filtered. Depending upon the iron concentration required for cleaning efficiency it may not be necessary to supplement the natural iron source by dosing with additional iron II or iron III. This may be applicable for example, in certain industrial processes or in mining processes. Iron ions may be added in to the feed water specifically to increase iron concentration in order that the reaction efficiency might be enhanced.

Alternatively, the approach of the present invention may be used to take advantage of existing iron species which are present in the filtration water. Ferric chloride (iron III) is commonly used as a flocculating agent to settle residual material prior to filtration, so that a clarified feed water can be passed through a filter. Ferric chloride may also be used to remove phosphorous during or after the filtration step. Thus, iron catalysts present in the water either from pre-treatment or for post treatment may be used to generate the redox catalyst/peroxide/H⁺ system of the present invention.

To expand on one example, iron II or iron III can be added in the feed water at an appropriate concentration to clarify water. After sedimentation, the clarified water is drawn off, containing iron II and/or iron III. This then introduced to a membrane, the pH is reduced to about pH4 and peroxide is added. Alternatively, the pH can be reduced and peroxide added prior to introduction to a membrane. The redox catalyst/peroxide/H⁺ system of the present invention may be passed through the membrane just once, or allowed to contact the membrane by standing for a time, or recirculated through the membrane or membrane system. The contact time is selected such that either a predetermined level of cleaning is achieved, as demonstrated by pressure drop, or a predetermined level of hydroxyl radicals is reached, below which the rate of cleaning is no longer practicable. If necessary, the iron II/iron III system remaining after the hydroxyl radicals is consumed may be re used by pH correction to about pH4 (if necessary) and reintroduction of further hydrogen peroxide.

Once used the catalyst iron may be recovered from the cleaning solution. Recovery can be effected either by recovering the entire cleaning solution for re-use or by flocculating the iron by raising the pH of the cleaning solution and then separating out the iron flocculants. In certain cases it may be necessary to aerate a solution of aqueous Fe II ions to oxidise the entire solution to Fe III. This would improve the efficiency of the Iron recovery step to above 90%.

Alternatively, Fe II/III system which has been used as a catalyst for the cleaning solution may be reused in the water filtration process in other ways, e.g. as a flocculent in the filtration process to improve the quality of the feed to the membranes, to improve or enhance the filtration performance and to improve and enhance the quality of the filtrate. These improvements may come from physical separation, such as flocculation, or by the chemical reaction with other dissolved species, such as phosphates. For example, iron may be used as a catalyst in the redox catalyst/peroxide/H⁺ system of the present invention following which the peroxide depleted cleaning solution may be used as a source of iron to flocculate either the feed or the filtrate. This may be done with or without further treatment of the peroxide depleted cleaning solution. In one example, fresh feed water is added to spent cleaning system containing FeII/III. The pH rises (or is neutralised) and the iron flocculates and clarifies the feed water prior to filtration.

Because the entire CIP solution of the present invention can be recycled, reduced waste is certainly a factor.

The invention may be applied to the filtration of surface water treatment, ground water treatment, desalination, treatment of secondary or tertiary effluent and membrane bioreactors.

Hydroxyl radical based cleaning systems, such as those based on the redox catalyst/peroxide/H⁺ system of the present invention can be used in existing systems and treatment process to improve quality of feed, filtrate or the performance of the filtration process itself. As such, they may be done in a batch process, or in a continuous process, for instance, where the Iron concentration immediately upstream of or at the membrane is measured, pH is adjusted and peroxide dosed in as appropriate to generate a predetermined concentration of hydroxyl radicals at the membrane. The cleaning methods are particularly suitable for cleaning in place (CIP) applications. Microfiltration and ultrafiltration membranes treated with the redox catalyst/peroxide/H⁺ system of the present invention show improved recovery from fouling of membranes used for water filtration.

An additional advantage provided by the methods of the present invention provide a self recirculating system in cases where vertical hollow fibre membranes are used. Most applications involve the use of hollow fibre membranes in a vertical orientation. Recirculation through the membrane improves the extent of the clean and is usually done by pumping cleaning solution through. In the present invention, in hollow fibre modules treated with the redox catalyst/peroxide/H⁺ system of the present invention, the solution flows through the membranes and out the top of the lumens which are typically 10 cm above water level. This is because the oxygen bubbles form in the lumens and displace water. This continuous displacement from evolving oxygen and the rising bubbles creates a flow that continues to draw more liquid in through the membrane wall and push water out of the top of the lumen. The rate of spontaneous flow expected from oxygen generation is in the range 0.01-50 lmh, with values about approx 0.2litres/m2.hr (lmh) in the most preferred concentration ranges for cleaning as discussed below.

Further, the nature of the reaction means that oxygen bubbles are evolved during the course of the reaction. This is particularly advantageous for cleaning membranes because it means the solutions are self agitating and continually refreshing the cleaning solution. The evolution of gas means that it breaks up the filter cake on the membrane surface. The evolution of oxygen is believed to synergistically enhance the cleaning process of the present invention.

The clean provided by the redox catalyst/peroxide/H⁺ system of the present invention has, in practice, proven to be low-foaming. In membrane bioreactors, where biological processes are involved, the micro organisms can become unsettled, leading to significant foaming. However, with the redox catalyst/peroxide/H⁺ system of the present invention, CIP involved no significant foaming. Without wishing to be bound by theory, it is believed that this is due to the fact that the disruption to micro organisms is not as drastic as in other cleans, and the micro organisms consequently do not take so long to settle back down.

Regardless of the type of cleaning situation, for example, reusing iron flocculating agents, allowing membranes stand in the redox catalyst/peroxide/H⁺ system of the present invention, making a single pass of the redox catalyst/peroxide/H⁺ system of the present invention through a membrane or recycling the redox catalyst/peroxide/H⁺ system of the present invention through a membrane, the concentration of Fe(II) or Fe(III) used will have the same broad requirements, and are best specified in terms of the overall amounts of reagents required.

Depending upon the source of the waste water and the other components present therein, chlorine and ozone can produce unwanted compounds, such as trihalomethanes. The cleaning methods of the present invention do not facilitate the production of trihalomethanes and the like. To the contrary, the cleaning methods of the present invention actually destroy, where present, trihalomethanes and the like.

Typically, a concentration less than 300 ppm of Fe can be used. Concentrations as low as 15-20 ppm Fe are efficacious, but the reaction time required is longer, for example, in excess of 24 hrs. Preferred concentrations are between 50-5000 ppm FeSO₄, and more preferably 300-1200 ppm. Contact times vary with the type of feed being filtered. Typical cleans are from 0.5-24 hrs but more preferably 2-4 hrs.

Peroxide concentrations are preferably between 100-20000 ppm, more preferably between 400 ppm and 10000 ppm and even more preferably between 1000-5000 ppm.

It is also preferable to have the ratio of Fe:H₂O₂ between 1:4 and 1:7.5, and more preferably between 1:5-1:25.

Preferably pH is in the range 2-6, more preferably 3-5. Lower pH's can be used if it is desired to have a ‘dual’ organic/inorganic clean. A dual clean is required in some CIP regimes. This involves both an acid clean (which may be an inorganic acid or, more usually an organic acid such as citric acid) to remove inorganic foulants and a chlorine clean to remove organic foulants. The use of the redox catalyst/peroxide/H⁺ system of the present invention has the advantage of providing both an acid and an oxidative clean in a single process.

A typical the redox catalyst/peroxide/H⁺ system of the present invention had a concentration of 0.12 wt % FeSO4 at pH2, and a peroxide concentration of between 5000 ppm and 9000 ppm.

The rate of addition of H₂O₂ is such that it is sufficient to add the equivalent amount of H₂O₂ over the time of the clean. For example, in the case of a 4000 ppm H₂O₂ concentration for a duration of 4 hours, H₂O₂ would be dosed at approximately 1000 ppm per hour.

Sodium hydrogen sulphate (NaHSO₄) can be used to control the pH. Sulfuric acid can be used, buffered with NaOH to get the desired pH. Chloride ions can be present, e.g. in the form of FeCl₃ of HCl. When the pH is lowered some HCl could be generated, which is a gas.

Any acid can be used, provided that the pH is in the right range. Preferably the system is a Sulfuric/Caustic combination or sulfuric/sodium hydrogen sulphate combination. Citric acid is also preferred as a pH control agent.

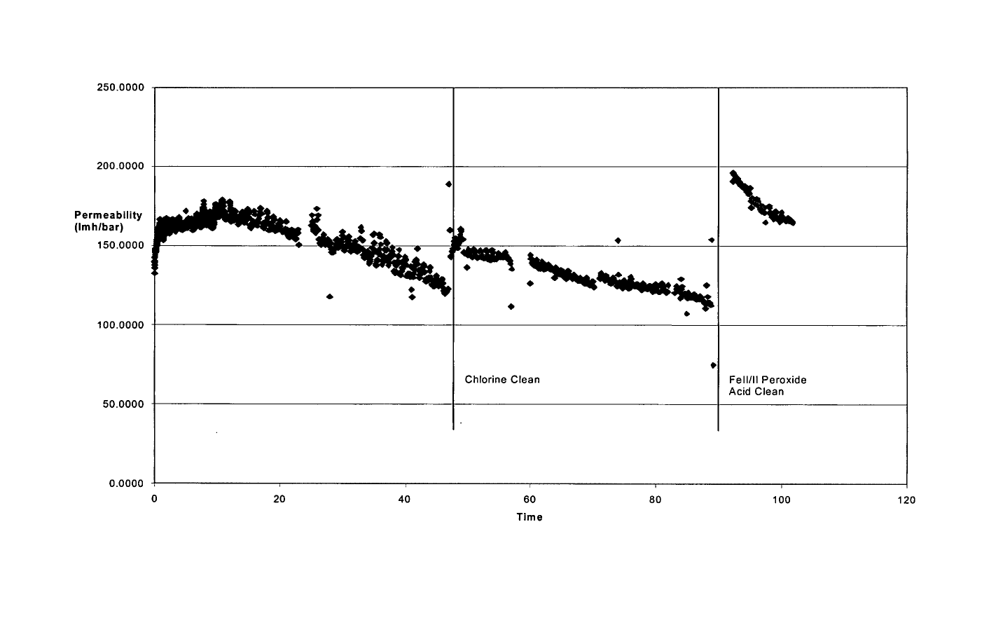

FIG. 1 shows the comparison of Chlorine clean and a clean provided by the redox catalyst/peroxide/H⁺ system of the present invention. FIG. 1 shows a cleaning in place (CIP) and illustrates the relative advantage over chlorine cleans which can be obtained from the redox catalyst/peroxide/H⁺ system of the present invention. The specific cleaning procedure for the two cleans performed is as follows:

Chlorine Clean:
1. 500 ppm chlorine rinse for 30 minutes
2. Liquid backwash for 2 minutes
3. 1500 ppm chlorine soak with intermittent aeration (30 sec every 10 minutes at 8 m3/hr) for 3 hours
4. Liquid backwash for 2 minutes
5. Drain down and restart

Clean provided by the redox catalyst/peroxide/H⁺ system of the present invention:
1. Rinse with tap water with intermittent aeration (8 m3/hr every 10 seconds, 300 seconds) for 15 minutes.
2. Fill filtrate tank with tap water and 8 L of H₂SO₄ & FeSO₄ solution (0.1% H₂SO₄ and 0.12% FeSO₄), 5.6 L of Peroxide (˜0.5%), pH=2.60.
3. Peroxide added to filtrate tank slowly with constant stirring.
4. Membrane tank filled and soak for 4 hours, with no aeration.
5. Drained down and restarted unit.

A used membrane was cleaned and allowed to filter a typical waste water feed. Starting permeability was around 150 lmh/bar. The permeability of the membrane began to drop in use as expected and eventually fell below initial levels to about 120 lmh/bar before the chlorine clean was commenced. The chlorine clean restored permeability to initial levels, but again dropped to about 120 lmh/bar in use as expected. At this point, a clean in accordance with the present invention was applied. The membrane permeability was restored to a point significantly better than at the start of the process, around 200 lmh/bar—almost an “as new” figure. The method of the present invention thus provided a significantly better clean than chlorine, with none of the attendant health or waste disposal issues.

1. A method for cleaning a microfiltration or ultrafiltration membrane comprising the step of contacting said membrane with a hydroxyl radical, wherein the hydroxyl radical is generated by one or more methods selected from the group consisting of: acidified hydrogen peroxide, organic peroxy acids, combinations of hydrogen peroxide and organic peroxy acids, hydrogen peroxide under ultraviolet radiation, a combination of hydrogen peroxide and ozone with or without ultraviolet radiation at a pH of between 2-9.

2. A method according to claim 1 wherein the microfiltration or ultrafiltration membrane is cleaned of biological fouling and/or organic fouling.

3. A method according to claim 1 wherein the membrane is an oxidation resistant membrane.

4. A method according to claim 3 wherein the microfiltration or ultrafiltration membrane is made from polyvinylidene fluoride (PVdF), copolymers of chlorotrifluoroethylene with ethylene, copolymers of chlorotrifluoroethylene with ethylene and one or more other monomers, or polysulfones.

5. A method according to claim 4 wherein the blend of chlorotrifluoroethylene with ethylene is Halar.

6. A method according to claim 1 wherein the hydroxyl radical is generated from acidified hydrogen peroxide, and acidified organic peroxy acid or a combination of acidified hydrogen peroxide and acidified organic peroxy acids.

7. A method according to claim 6 wherein the organic peroxy acid is peracetic acid.

8. A method according to claim 6 wherein the hydroxyl radical is generated from acidified hydrogen peroxide.

9. A method according to claim 8 wherein the hydroxyl radical is generated by treating hydrogen peroxide with ultraviolet radiation.

10. A method according to claim 1 wherein the hydroxyl radical is generated by a combination of hydrogen peroxide and ozone.

11. A method according to claim 1 wherein the hydroxyl radicals are generated from an aqueous solution of transition metal (M) ions, in conjunction with hydrogen peroxide under acidic conditions.

12. A method according to claim 11 wherein the hydroxyl radicals are generated from an aqueous solution of transition metal (M) ions present as a complex with a chelating agent, in conjunction with hydrogen peroxide under acidic conditions.

13. A method according to claim 12 wherein the chelating agent is citric acid.

14. A method according to claim 11 wherein the solution of hydroxyl radicals is prepared from an aqueous solution of M⁽ⁿ⁺⁾ and/or M⁽ⁿ⁺¹⁾⁺ in conjunction with hydrogen peroxide at a low pH.

15. A method according to claim 11 wherein the acidic conditions are a pH of between about pH 2-6.

16. A method according to claim 11 wherein the transition metal is iron.

17. A method according to claim 11 wherein the transition metal is molybdenum, chromium, cobalt, copper or tungsten.

18. A method according to claim 11 wherein the transition metal is any aqueous metal ion or complex that can easily be reduced/oxidised

19. A method according to claim 16 wherein M⁽ⁿ⁺⁾ and/or M⁽ⁿ⁺¹⁾⁺ is an iron II and/or iron III system

20. A method according to claim 19 wherein the iron II and/or iron III system solution is prepared from ferrous species or ferric species.

21. A method according to claim 11 which is catalytic with respect to the transition metal.

22. A method according to claim 1 wherein the microfiltration or ultrafiltration membrane is soaked with a solution containing hydroxyl radicals.

23. A method according to claim 22 further including an aeration step and/or irradiating the solution with ultraviolet light to assist in cleaning.

24. A method according to claim 1 wherein a solution containing hydroxyl radicals is filtered or recirculated through the membrane.

25. A method according claim 24 further including an aeration step and/or irradiating the solution with ultraviolet light to assist in cleaning.

26. A method according to claim 11 wherein individual transition metal/peroxide/H⁺ components are added together to water which surrounds the microfiltration or ultrafiltration membranes.

27. A method according to claim 11 wherein individual transition metal/peroxide/H⁺ components are added separately directly to water which surrounds the microfiltration or ultrafiltration membranes.

28. A method according to claim 11 wherein the transition metal is native to feed water for the microfiltration or ultrafiltration membrane.

29. A method according to claim 11 wherein iron II or iron III are added to microfiltration or ultrafiltration membrane feed water at an appropriate concentration to clarify water, the water is allowed to stand and sediment, whereupon after sedimentation, the clarified water containing iron II and/or iron III is drawn off, introduced to a microfiltration or ultrafiltration membrane, the pH is reduced to about pH4 and peroxide is added, whereupon membrane cleaning occurs.

30. A method according to claim 11 wherein iron II or iron III are added to microfiltration or ultrafiltration membrane feed water at an appropriate concentration to clarify water, the water is allowed to stand and sediment, whereupon after sedimentation, the clarified water containing iron II and/or iron III is drawn off, the pH is reduced to about pH4 and peroxide is added, and the resultant solution is introduced to a microfiltration or ultrafiltration membrane, whereupon membrane cleaning occurs.

31. A method according to claim 11 wherein an acidified iron II or iron III solution in combination with peroxide is used to clean a membrane, and subsequent to cleaning the membrane, a spent cleaning solution containing iron II or iron III is further used in water filtration.

32. A method according to claim 31 wherein the spent cleaning solution containing iron II or iron III is added to fresh feed water.

33. A method according to claim 31 wherein the spent cleaning solution containing iron II or iron III is used to remove phosphorus.

34. A method according to claim 31 wherein the spent cleaning solution containing iron II or iron III is used as a flocculent

35. A method according to claim 1 wherein contact time between the microfiltration or ultrafiltration and the hydroxyl radical is selected such that a predetermined level of cleaning is achieved.

36. A method according to claim 35 wherein a predetermined level of cleaning is demonstrated by a predetermined transmembrane pressure drop.

37. A method according to claim 35 wherein a predetermined level of cleaning is demonstrated by a predetermined hydroxyl radical concentration.

38. A method according to claim 1 conducted in a batchwise process

39. A method according to claim 1 conducted in a continuous process

40. A method according to claim 1 wherein the microfiltration or ultrafiltration membranes include hollow fibre membranes.

41. A method according to claim 40 wherein oxygen bubbles formed in the course of the reaction create a flow that draws more liquid in through a wall of a vertical hollow fibre membrane and pushes water out of the top of the lumen.

42. A method according to claim 1 wherein oxygen bubbles act to self agitating a solution containing the hydroxyl radicals and/or break up a filter cake, where present, on the microfiltration or ultrafiltration membrane surface.

43. A method according to claim 1 used in a membrane bioreactor.

44. A method according to claim 1 which destroys, where present, trihalomethanes and the like.

45. A method according to claim 11 wherein concentrations of 15-5000 ppm transition metal ion are used.

46. A method according to claim 45 wherein concentrations of 300-1200 ppm transition metal ion are used.

47. A method according to claim 1 wherein the contact time between the microfiltration or ultrafiltration membrane and the hydroxyl radical is between 0.5-24 hrs.

48. A method according to claim 47 wherein the contact time between the microfiltration or ultrafiltration membrane and the hydroxyl radical is between 2-4 hrs.

49. A method according to claim 6 wherein the peroxide concentration is between 100-20000 ppm

50. A method according to claim 49 wherein the peroxide concentration is between 400 ppm and 10000 ppm

51. A method according to claim 49 wherein the peroxide concentration is between 1000-5000 ppm.

52. A method according to claim 11 wherein a ratio of transition metal:H₂O₂ is between 1:4 and 1:7.5.

53. A method according to claim 52 wherein a ratio of transition metal:H₂O₂ is between 1:5-1:25.

54. A method according to claim 11 wherein the transition metal/peroxide/H⁺ system has a starting concentration of 0.12 wt % FeSO₄ at pH2 and a peroxide concentration of between 5000 ppm and 9000 ppm.

55. A method according to claim 1 wherein sodium hydrogen sulphate is used to control pH.

56. A method according to claim 1 wherein citric acid is used to control pH.

57. A method according to claim 1 wherein pH is controlled by sulfuric acid buffered with NaOH.
